(19) United States
(12) Patent Application Publication
(10) Pub. No.: US 2016/0378911 A1
(43) Pub. Date: Dec. 29, 2016

(54) METHOD AND APPARATUS FOR DISCOVERING TARGET PROTEIN OF TARGETED THERAPY

(71) Applicants: SAMSUNG ELECTRONICS CO., LTD., Suwon-si (KR); KOREA ADVANCED INSTITUTE OF SCIENCE AND TECHNOLOGY, Daejeon (KR)

(72) Inventors: Misook HA, Hwaseong-si (KR); Kwang-Hyun CHO, Daejeon (KR); Sung-Hwan CHO, Daejeon (KR); Sang-Min PARK, Daejeon (KR); Ho-Sung LEE, Daejeon (KR); Hwang-Yeol LEE, Daejeon (KR)

(21) Appl. No.: 15/196,656

(22) Filed: Jun. 29, 2016

(30) Foreign Application Priority Data
Jun. 29, 2015 (KR) 10-2015-0091956

(51) Int. Cl. G06F 19/12; G06F 19/28; C40B 30/02

(52) U.S. Cl. CPC G06F 19/12; C40B 30/02; G06F 19/28

(57) ABSTRACT

An exemplary embodiment of the invention provides a discovery method of a protein which serves as a target of a target therapy, including: performing an attractor analysis on a first body signal transferring network of a cancer cell that is perturbed, and determining at least one of a plurality of proteins included in a third body signal transferring network of a cancer cell as a target protein based on the attractor analysis on the first body signal transferring network and an attractor analysis on a second body signal transferring network of a normal cell.

### CROSS-REFERENCE TO RELATED APPLICATION

This application claims priority to Korean Patent Application No. 10-2015-0091956, filed on Jun. 29, 2015, and all the benefits accruing therefrom under 35 U.S.C. §119, the content of which in its entirety is herein incorporated by reference.

### BACKGROUND

(a) Field

Exemplary embodiments of the invention relate to a method and an apparatus for discovering a protein which serves as a target of a target therapy in a body signal transferring network.

(b) Description of the Related Art

Cancer is one of typical complex system diseases, and occurs in about 34 percent of male adults and about 29 percent of female adults. The incidence rate of cancer has been rapidly increasing every year, and it is expected that there will be about 180,000 cancer patients in 2015 in Korea, for example. Although researchers around the world use an astronomical amount of research funds every year to overcome cancer, they have not yet accomplished an impressive result due to misunderstanding of cancer development, progression, and mechanisms, as well as the absence of systemic analysis.

Conventionally, a method of using combinations of anti-cancer agents has been used to overcome multi-drug resistant cancer. However, simply using the combinations of anti-cancer agents makes it difficult to suggest a method of treating specific cancers caused by specific mutagenesis.

Therefore, a target therapy which may selectively attack cancer cells while minimizing damage to normal cells has been researched to reduce adverse reactions to the conventional anti-cancer agents. The target therapy may prevent cancer from developing and spreading by suppressing actions of specific molecules relating to cancer growth and development. Further, a cancer-treating solution using a body signal transferring network has been being researched to recognize a living thing as one system beyond the viewpoint of a protein or a single gene which specializes in a particular function.

### SUMMARY

The invention has been made in an effort to provide a method and an apparatus for effectively discovering a protein which serves as a target of a target therapy by using a body signal transferring network and a Boolean network model.

An exemplary embodiment of the invention provides a discovery method of a protein which serves as a target of a target therapy, including performing an attractor analysis on a first body signal transferring network of a cancer cell that is perturbed, and determining at least one of a plurality of proteins included in a third body signal transferring network of a cancer cell as a target protein based on the attractor analysis on the first body signal transferring network and an attractor analysis on a second body signal transferring network of a normal cell.

In an exemplary embodiment, the performing may include modeling the third body signal transferring network by applying a mutation map of a cancer state to the second body signal transferring network, modeling the first body signal transferring network by perturbing at least one of a plurality of proteins included in the third body signal transferring network, and simulating a signal-transmitting operation of the first body signal transferring network by using a Boolean network model.

In an exemplary embodiment, the modeling of the first body signal transferring network may include modeling the first body signal transferring network by perturbing a combination of some of a plurality of proteins included in the third body signal transferring network.

In an exemplary embodiment, the simulating may includes determining the Boolean network model relating to a mutual relationship of the proteins included in the first body signal transferring network, and time-dynamically simulating the first body signal transferring network based on the Boolean network model.

In an exemplary embodiment, the simulating may include generating a truth table relating to the mutual relationship of the proteins included in the first body signal transferring network based on the Boolean network model, generating a state transition table showing state transition of the proteins based on the truth table, and determining an attractor indicating a final state of each protein included in the first body signal transferring network by generating a state transition diagram based on the state transition table.

In an exemplary embodiment, the simulating may include calculating a basin size of an attractor of the perturbed cancer cell based on the simulation result of the first body signal transferring network.

In an exemplary embodiment, the determining may include comparing a basin size of an abnormal one of attractors of the normal cell with a basin size of an abnormal one of attractors of the perturbed cancer cell, and, when a difference between the basin size of the abnormal one of the attractors of the normal cell with the basin size of the abnormal one of the attractors of the perturbed cancer cell is smaller than a predetermined value, determining at least one perturbed protein of the proteins included in the third body signal transferring network as the target protein.

In an exemplary embodiment, the determining may include comparing a first basin size ratio of normal attractors and abnormal attractors among attractors of the normal cell with a second basin size ratio of normal attractors and abnormal attractors among attractors of the perturbed cancer cell, and, when a difference between the first basin size ratio and the second basin size ratio is smaller than a predetermined value, determining at least one perturbed protein of the proteins included in the third body signal transferring network as the target protein.

In an exemplary embodiment, the determining may further include, when at least two of the proteins included in the third body signal transferring network are the target protein, determining at least one of combinations of the at least two proteins as the target protein.

In an exemplary embodiment, the determining may include, when at least two of the proteins included in the third body signal transferring network are the target protein generating a fourth body signal transferring network by making combinations of the at least two proteins and perturbing the combinations of the at least two proteins, and re-performing the attractor analysis on the fourth body signal transferring network.

An exemplary embodiment of the invention provides a discovery apparatus of a protein which serves as a target of a target therapy, including at least one processor, a memory, and a transceiver, wherein the at least one processor executes at least one program stored in the memory to perform performing an attractor analysis on a first body signal transferring network of a cancer cell that is perturbed, and determining at least one of a plurality of proteins included in a third body signal transferring network of a cancer cell as a target protein based on the attractor analysis on the first body signal transferring network and an attractor analysis on a second body signal transferring network of a normal cell.

In an exemplary embodiment, the at least one processor may perform modeling the third body signal transferring network by applying a mutation map of a cancer state to the second body signal transferring network, modeling the first body signal transferring network by perturbing at least one of a plurality of proteins included in the third body signal transferring network, and simulating a signal-transmitting operation of the first body signal transferring network by using a Boolean network model.

In an exemplary embodiment, the at least one processor, when performing the modeling of the first body signal transferring network, may perform modeling the first body signal transferring network by perturbing a combination of some of a plurality of proteins included in the third body signal transferring network.

In an exemplary embodiment, the at least one processor, when performing the simulating, may perform determining the Boolean network model relating to a mutual relationship of the proteins included in the first body signal transferring network, and time-dynamically simulating the first body signal transferring network based on the Boolean network model.

In an exemplary embodiment, the at least one processor, when performing the simulating, may perform generating a truth table relating to the mutual relationship of the proteins included in the first body signal transferring network based on the Boolean network model, generating a state transition table showing state transition of the proteins based on the truth table, and determining an attractor indicating a final state of each protein included in the first body signal transferring network by generating a state transition diagram based on the state transition table.

In an exemplary embodiment, the at least one processor may perform calculating a basin size of an attractor of the perturbed cancer cell based on the simulation result of the first body signal transferring network.

In an exemplary embodiment, the at least one processor, when performing the determining, may perform comparing a basin size of an abnormal one of attractors of the normal cell with a basin size of an abnormal one of attractors of the perturbed cancer cell, and, when a difference between the basin size of the abnormal one of the attractors of the normal cell with the basin size of the abnormal one of the attractors of the perturbed cancer cell is smaller than a predetermined value, determining at least one perturbed protein of the proteins included in the third body signal transferring network as the target protein.

In an exemplary embodiment, the at least one processor, when performing the determining, may perform comparing a first basin size ratio of normal attractors and abnormal attractors among attractors of the normal cell with a second basin size ratio of normal attractors and abnormal attractors among attractors of the perturbed cancer cell, and, when a difference between the first basin size ratio and the second basin size ratio is smaller than a predetermined value, determining at least one perturbed protein of the proteins included in the third body signal transferring network as the target protein.

In an exemplary embodiment, the at least one processor, when performing the determining, may perform, when at least two of the proteins included in the third body signal transferring network are determined as the target protein, determining at least one of combinations of the at least two proteins as the target protein.

In an exemplary embodiment, the at least one processor, when performing the determining, performs, when at least two of the proteins included in the third body signal transferring network are determined as the target protein generating a fourth body signal transferring network by making combinations of the at least two proteins and perturbing the combinations of the at least two proteins, and re-performing the attractor analysis on the fourth body signal transferring network.

According to the exemplary embodiment of the invention, it is possible to develop an effective target therapy for a disease such as a cancer caused by activation or inactivation of a specific protein by determining a target protein by calculation of a basin size of an attractor of a body signal transferring network through the Boolean network model.

### BRIEF DESCRIPTION OF THE DRAWINGS

The above and other exemplary embodiments, advantages and features of this disclosure will become more apparent by describing in further detail exemplary embodiments thereof with reference to the accompanying drawings, in which:

FIG. 1 illustrates an exemplary embodiment of a body signal transferring network according to the invention.

FIG. 2 is a flowchart illustrating an exemplary embodiment of a target protein discovery method according to the invention.

FIG. 3 illustrates an exemplary embodiment of a Boolean network model according to the invention.

FIG. 4 is a state transition diagram in accordance with an exemplary embodiment of a target protein discovery method according to the invention.

FIG. 5 illustrates an exemplary embodiment of attractor areas that are provided by simulating a body signal transferring network with a Boolean network model according to the invention.

FIGS. 6A to 6E are graphs illustrating size variations of an exemplary embodiment of cell basins of colorectal cancer according to the invention.

FIGS. 7A to 7D are graphs illustrating size variations of an exemplary embodiment of cell basins of colorectal cancer per each attractor type according to the invention.

FIG. 8 is a graph illustrating an exemplary embodiment of a discovery result of target proteins according to the invention.

FIG. 9 illustrates an exemplary embodiment of cell attractor areas according to the invention.

FIG. 10 illustrates an exemplary embodiment of a method of expecting an effect of a target therapy of a target protein according to the invention.

FIG. 11 is a block diagram illustrating an exemplary embodiment of a protein discovery apparatus according to the invention.

### DETAILED DESCRIPTION

In the following detailed description, only certain exemplary embodiments of the invention have been shown and described, simply by way of illustration. As those skilled in the art would realize, the described embodiments may be modified in various different ways, all without departing from the spirit or scope of the invention. Accordingly, the drawings and description are to be regarded as illustrative in nature and not restrictive. Like reference numerals designate like elements throughout the specification.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. In an exemplary embodiment, when the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, when the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. In an exemplary embodiment, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

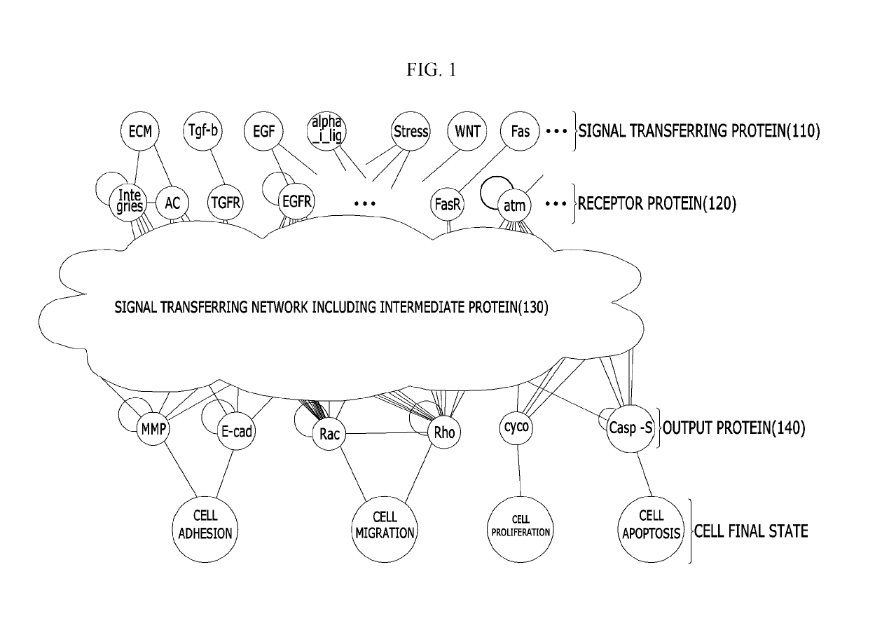

FIG. 1 illustrates a body signal transferring network according to an exemplary embodiment of the invention.

Referring to FIG. 1, the body signal transferring network according to the exemplary embodiment shows an operation that transfers signals between a plurality of proteins included in one cell. In the body signal transferring network according to the exemplary embodiment, a signal that is transferred from the outside of a cell to the cell is transferred to an intermediate protein 130 through a signal transferring protein 110 and a receptor protein 120. When the transferred signal reaches an output protein 140 positioned at a last stage of the network, a final state of the cell may be determined according to types of the output protein 140. In this case, the final state of the cell may be determined as one of cell adhesion, cell migration, cell proliferation, and cell apoptosis by the signal transferred from the outside. When the state of the cell is abnormally changed by mutation, the cell may be changed into a cancer cell. The body signal transferring network according to the exemplary embodiment may be provided based on information related to signal transferring between living molecules, which is collected from a biochemical pathway database such as KEGG (“Kyoto Encyclopedia of Genes and Genomes”), NCI (“National Cancer Institute”), and BioCarta.

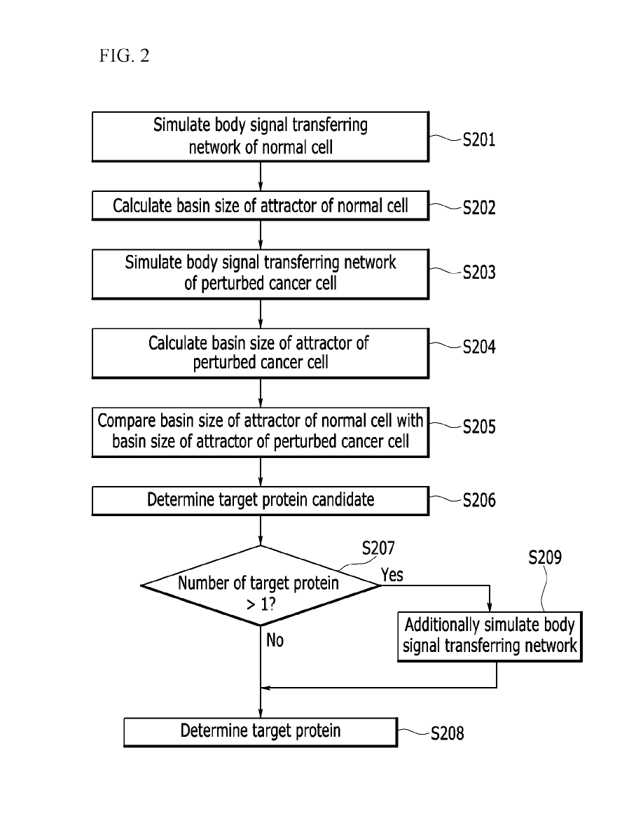

FIG. 2 is a flowchart illustrating a target protein discovery method according to an exemplary embodiment of the invention.

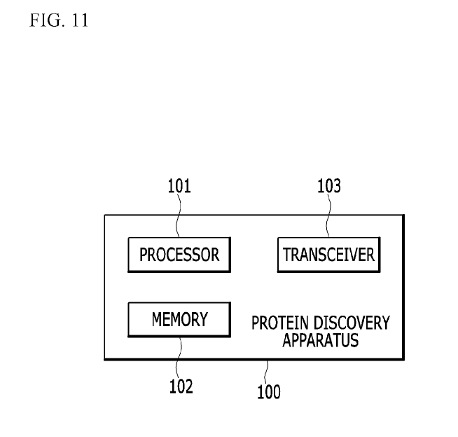

First, a protein discovery apparatus 100 (refer to FIG. 11) according to the exemplary embodiment performs attractor analysis on a body signal transferring network by using a Boolean network model. The protein discovery apparatus 100 according to the exemplary embodiment may analyze a dynamic operation in which a signal transferred from the outside of a cell is transferred through proteins included in the cell by modeling a body signal transferring network modeled on a normal cell by use of a Boolean network model, to perform attractor analysis on the body signal transferring network (S201).

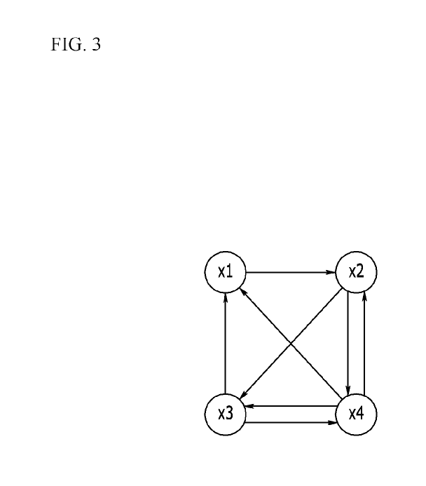

The Boolean network model according to the exemplary embodiment of the invention, which is a modeling method for indicating an active state of living molecules as activity (on) and non-activity (off), may model a discrete dynamical network having time and states of discrete values. Nodes of the Boolean network model include a plurality of protein molecules (xₙ), and each node may indicate states of the protein molecules. Further, each node may be connected to at least one link. Hereinafter, a method of simulating a signal transferring operation of the body signal transferring network by the protein discovery apparatus 100 based on the Boolean network model according to an exemplary embodiment of the invention will be described in detail with reference to FIG. 3 and Tables 1 to 4.

FIG. 3 illustrates a Boolean network model according to an exemplary embodiment of the invention.

Referring to FIG. 3, each of proteins x₁, x₂, x₃, and x₄ of the Boolean network model corresponds to one corresponding protein. The Boolean network model according to the exemplary embodiment shows a mutual relationship of proteins included in the body signal transferring network.

In a truth table of the Boolean network model, when each protein is in an active (on) state, proteins x₁, x₂, x₃, and x₄ may be indicated by ‘1,’ and when each protein is in a non-active (off) state, the proteins x₁, x₂, x₃, and x₄ may be indicated by ‘0.’

Tables 1 to 4 show truth tables of the Boolean network illustrated in FIG. 3.

TABLE 1

| Previous | Current |
|---|---|
| x₃ x₄ | x₁ |
| 0 0 | 0 |
| 0 1 | 1 |
| 1 0 | 0 |
| 1 1 | 0 |

TABLE 2

| Previous | Current |
|---|---|
| x₁ x₄ | x₂ |
| 0 0 | 0 |
| 0 1 | 1 |
| 1 0 | 0 |
| 1 1 | 0 |

TABLE 3

| Previous | Current |
|---|---|
| x₂ x₄ | x₃ |
| 0 0 | 1 |
| 0 1 | 1 |
| 1 0 | 0 |
| 1 1 | 1 |

TABLE 4

| Previous | Current |
|---|---|
| x₂ x₃ | x₄ |
| 0 0 | 0 |
| 0 1 | 1 |
| 1 0 | 0 |
| 1 1 | 1 |

Referring to FIG. 3 and Tables 1 to 4, a current state of the protein x₁ may be determined according to previous states of the proteins x₃ and x₄, a current state of the protein x₂ may be determined according to previous states of the proteins x₁ and x₄, a current state of the protein x₃ may be determined according to previous states of the proteins x₂ and x₄, and a current state of the protein x₄ may be determined according to previous states of the proteins x₂ and x₃.

Further, a link of the Boolean network model may represent positive or negative actions. In this case, the positive action indicates an activation action, and the negative action indicates an inhibition action.

A simulation by the Boolean network model may be performed according to a discrete time step. In an exemplary embodiment, a state of a specific node at a time [t+1] may be determined by a state of an input node of a link connected to the specific node at a time [t], for example. In this case, when the time passes from the time t to the time t+1, states of all nodes may be simultaneously updated.

Referring back to FIG. 2, the protein discovery apparatus 100 according to the exemplary embodiment calculates a basin size of an attractor based on a simulation result of the body signal transferring network on a normal cell (S202).

When the Boolean network model includes n protein molecules where n is a natural number, there may be 2ⁿ states of the Boolean network model at a maximum. Referring to FIG. 3, since the Boolean network model includes 4 protein molecules, there may be 16 (=2⁴) possible states of the Boolean network model at a maximum.

An attractor indicates a final state of a body signal transferring network that is finally converged by the body signal transferring network simulated by using the Boolean network model. In an exemplary embodiment, after a simulation of the body signal transferring network by the Boolean network model is performed in a discrete time step, the nodes of the Boolean network model are converged into at least one specific node. In this case, it may be determined as an attractor. Attractors of at least one attractor included in one Boolean network model are exclusive to each other.

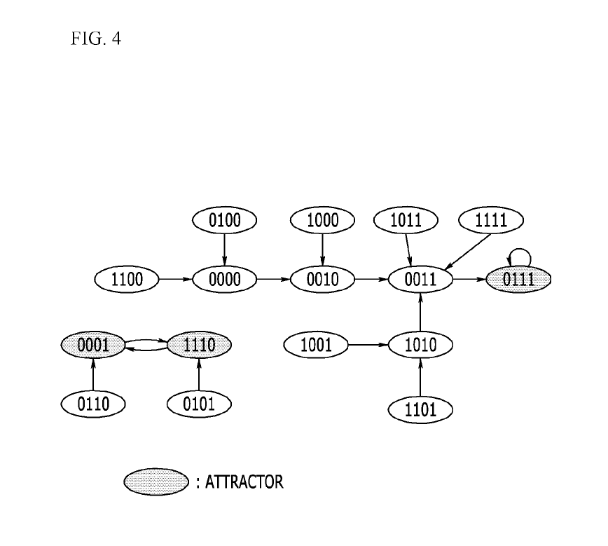

A method of discovering an attractor and calculating a basin area of the attractor will be described in detail with reference to FIG. 4 and Table 5.

FIG. 4 is a state transition diagram in accordance with a target protein discovery method according to an exemplary embodiment of the invention, and Table 5 is a state transition table according to the truth table of one Boolean network. The state transition diagram is illustrated according to the state transition table of Table 5.

TABLE 5

| | |
|---|---|
| t | t + 1 |

| x₁ | x₂ | x₃ | x₄ | x₁ | x₂ | x₃ | x₄ |
|---|---|---|---|---|---|---|---|
| 0 | 0 | 0 | 0 | 0 | 0 | 1 | 0 |
| 0 | 0 | 0 | 1 | 1 | 1 | 1 | 0 |
| 0 | 0 | 1 | 0 | 0 | 0 | 1 | 1 |
| 0 | 0 | 1 | 1 | 0 | 1 | 1 | 1 |
| 0 | 1 | 0 | 0 | 0 | 0 | 0 | 0 |
| 0 | 1 | 0 | 1 | 1 | 1 | 1 | 0 |
| 0 | 1 | 1 | 0 | 0 | 0 | 0 | 1 |
| 0 | 1 | 1 | 1 | 0 | 1 | 1 | 1 |
| 1 | 0 | 0 | 0 | 0 | 0 | 1 | 0 |
| 1 | 0 | 0 | 1 | 1 | 0 | 1 | 0 |
| 1 | 0 | 1 | 0 | 0 | 0 | 1 | 1 |
| 1 | 0 | 1 | 1 | 0 | 0 | 1 | 1 |
| 1 | 1 | 0 | 0 | 0 | 0 | 0 | 0 |
| 1 | 1 | 0 | 1 | 1 | 0 | 1 | 0 |
| 1 | 1 | 1 | 0 | 0 | 0 | 0 | 1 |
| 1 | 1 | 1 | 1 | 0 | 0 | 1 | 1 |

In FIG. 4, the Boolean network model according to the illustrated exemplary embodiment includes 4 proteins x₁, x₂, x₃, and x₄, and one node shown in the state transition diagram indicates a state of the Boolean network model at a time t. Referring to FIG. 4, a node whose state is ‘1011’ and ‘1111’ at the time t is changed into ‘0011’ at a time t+1. A node of ‘1000’ at the time t is changed into ‘0010’ at the time t+1, and is changed into ‘0011’ at a time t+2. In FIG. 4, the state transition diagram of the Boolean network model including four proteins is illustrated, and thus there may be a total of 16 (=2⁴) states. When n proteins are simulated through the Boolean network model, there may be a total of 2ⁿ states.

Referring to FIG. 4, ‘0001’, ‘1110’, and ‘0111’ indicate attractors according to the illustrated exemplary embodiment. Specifically, all states of the Boolean network model according to the illustrated exemplary embodiment are finally converged into ‘0001’, ‘1110’, and ‘0111’. In this case, the states of ‘0001’, ‘1110’, and ‘0111’ are referred to as attractors. In this case, the respective attractors may be classified into normal attractors and abnormal attractors. In this regard, the attractors of the illustrated exemplary embodiment may be divided into normal attractors and abnormal attractors according to the following three criteria.

First, when a cell proliferation operation is adjustable as in normal cells, the attractors may be classified into normal attractors, and otherwise, the attractors may be classified into abnormal attractors. In this case, it may be determined according to activity of a CyclinD gene whether the cell proliferation operation is adjustable.

Second, when the cell proliferation operation is properly performed, the attractors may be classified into normal attractors, and otherwise, the attractors may be classified into abnormal attractors. In this case, it may be determined according to whether the activation is performed in order of CyclinD→CyclinE→CyclinA→CyclinB whether the cell proliferation operation is properly performed.

Third, when cell migration exists, the attractors may be classified into abnormal attractors. When there is no cell migration, the attractors may be classified into normal attractors. In this case, the cell migration may be determined based on an activation state of Rho and MMP genes.

In an exemplary embodiment, the attractors according to the illustrated exemplary embodiment include fixed-point attractors and circle attractors, for example. The fixed-point attractors indicate attractors having one state, and the circle attractors indicate attractors having two or more states. Referring to FIG. 4, ‘0111’ indicates a fixed-point attractor, and ‘0001’ and ‘1110’ indicate circle attractors. In the illustrated exemplary embodiment, an attractor discovered through the state transition diagram may be represented as an attractor area.

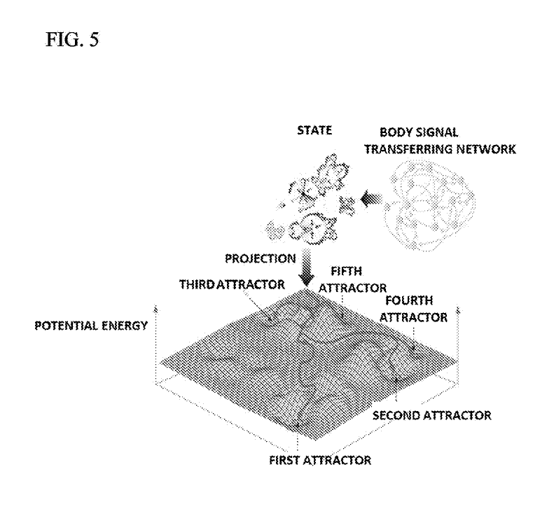

FIG. 5 illustrates attractor areas that are provided by simulating a body signal transferring network with a Boolean network model according to an exemplary embodiment of the invention.

Referring to FIG. 5, when the body signal transferring network modeled according to the exemplary embodiment is simulated by using the Boolean network model, a state changing operation of each node may be represented. In FIG. 5, the state of each node obtained by the simulation of the body signal transferring network is projected on the attractor area indicated by a lattice. In other words, in FIG. 5, one lattice provided by an x-axis and a y-axis may correspond to one state, and a z-axis represents a potential energy of each state. In an exemplary embodiment, ‘0100’ and ‘1100’ of FIG. 4 have position energies which are higher than ‘0000’, and thus a next state of ‘0100’ and ‘1100’ is changed into ‘0000’, for example. In other words, a state having the smallest position energy in FIG. 5 may be ‘0001’, ‘1110’, and ‘0111’ of FIG. 4, and may be an attractor in the illustrated exemplary embodiment.

Referring to FIG. 5, the basin size of an attractor included in the attractor area may be calculated based on the number of states included in the basin. In other words, in FIG. 5, one state may correspond to one lattice, and thus the basin size may be the number of lattices. In FIG. 4, when ‘0001’ and ‘1110’ are first attractors and ‘0111’ is a second attractor, the basin size of the first attractor may be two and the basin size of the second attractor may be one.

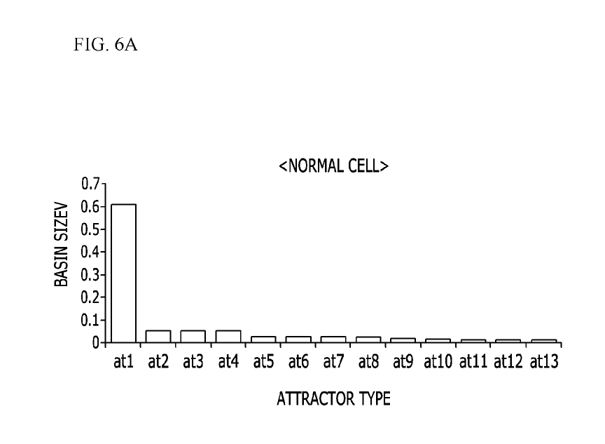

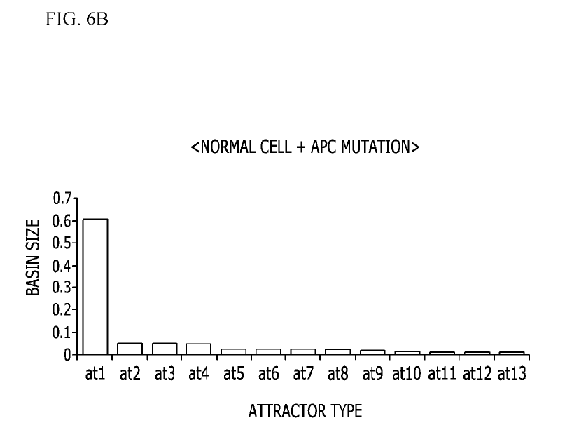

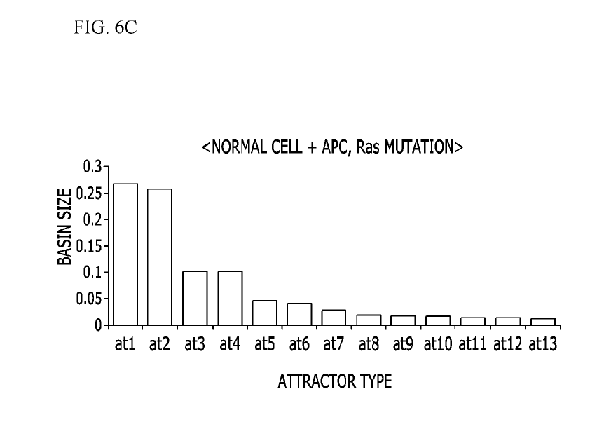

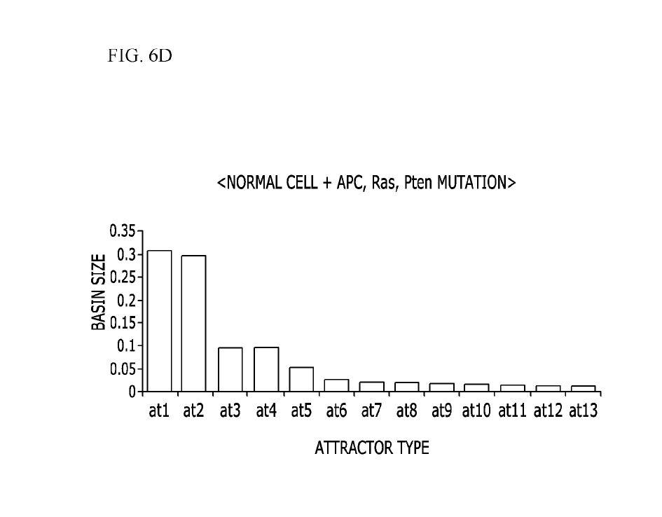

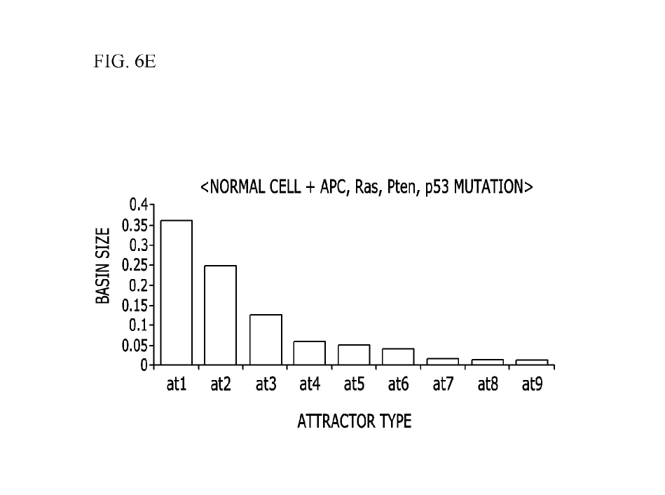

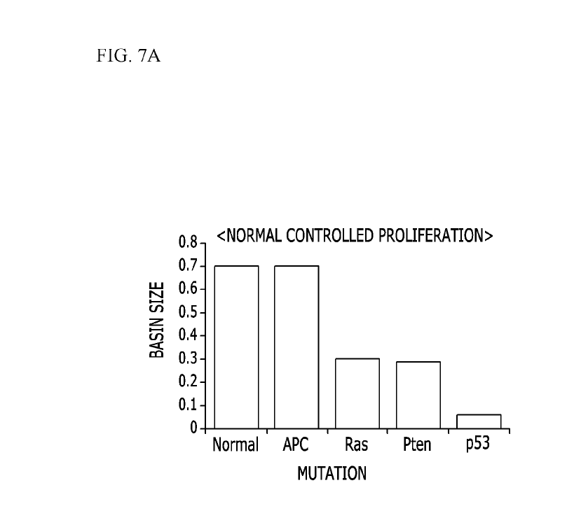

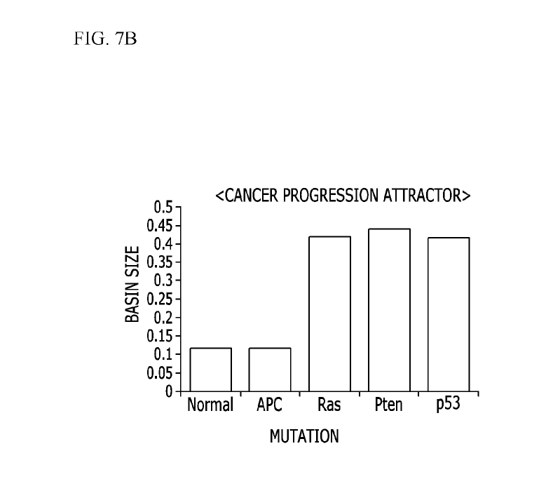

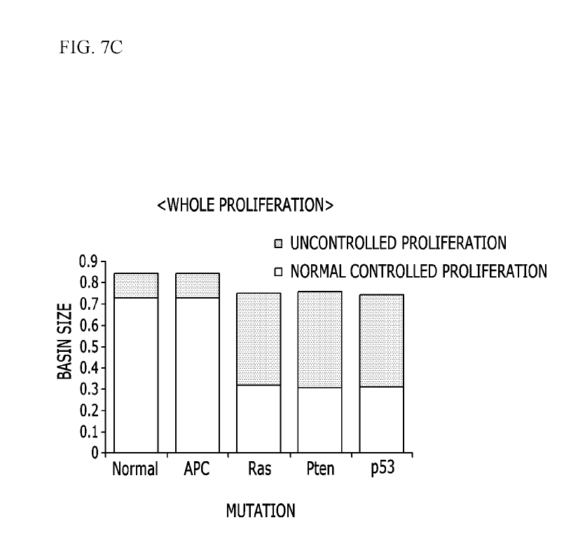

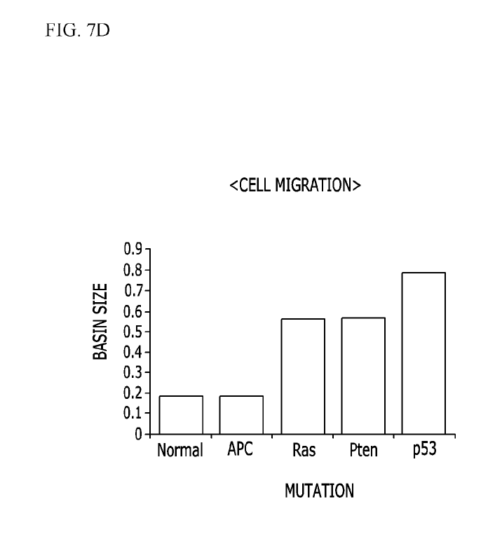

Hereinafter, a change in the basin size of a cancer cell will be described with reference to FIGS. 6A to 6E and FIGS. 7A to 7D.

FIGS. 6A to 6E are graphs illustrating size variations of cell basins of colorectal cancer according to an exemplary embodiment of the invention, and FIGS. 7A to 7D are graphs illustrating size variations of cell basins of colorectal cancer per each attractor type according to an exemplary embodiment of the invention.

The colorectal cancer as a representative cancer disease occurs when mutation is sequentially generated in a normal cell in order of APC→Ras→Pten→p53 genes. FIG. 6A illustrates a basin size of each attractor for a normal cell, FIG. 6B illustrates a basin size of each attractor when a mutation is generated at an APC gene in the normal cell, FIG. 6C illustrates a basin size of each attractor when a mutation is generated at the APC gene and a Ras gene in the normal cell, FIG. 6D illustrates a basin size of each attractor when a mutation is generated at the APC gene, the Ras gene, and a Pten gene in the normal cell, and FIG. 6E illustrates a basin size of each attractor when a mutation is generated at the APC gene, the Ras gene, a Pten gene, and a p53 gene in the normal cell. In FIGS. 6A to 6E, the horizontal axis indicates an attractor type, and the vertical axis indicates a basin size of each attractor. Referring to FIGS. 6A and 6B, although an APC gene mutation is generated in a normal cell, the basin size of each attractor is hardly changed. In brief, the APC gene is not determined by a target protein for the colorectal cancer cell.

However, referring to FIGS. 6C, 6D, and 6E, the basin size of each attractor is changed whenever a mutation is generated at the Ras gene, the Pten gene, and the p53 gene in the normal cell. In this case, by determining whether the attractor whose basin size is changed is normal or abnormal, it is possible to determine which protein is a target protein for the colorectal cancer cell among the Ras gene, the Pten gene, and the p53 gene.

FIG. 7A illustrates a basin size of a normal controlled-proliferation state (i.e., normal attractor) according to each mutation, FIG. 7B illustrates a basin size of a cancer-progression attractor (i.e., abnormal attractor) according to each mutation, FIG. 7C illustrates a basin size ratio of a controlled-proliferation state and an uncontrolled-proliferation state according to each mutation, and FIG. 7D illustrates a basin size of a cell-migration state (i.e. abnormal attractor) according to each mutation.

Referring to FIG. 7A, as gene mutation is accumulated, the basin size of the normal controlled-proliferation state indicating proliferation of a normal cell is reduced, and the basin size of the cancer-progression attractor is increased. Further, referring to FIG. 7C, the basin size sum of the controlled-proliferation state and the uncontrolled-proliferation state is not significantly changed, and thus the proliferation of all cells is similarly maintained even though the mutation is accumulated, but the basin size of the uncontrolled-proliferation state occupies more space. In other words, when the mutation is generated at the Ras, Pten, and p53 genes, the basin size of the uncontrolled-proliferation state which may be classified into the abnormal attractor is increased. In addition, referring to FIG. 7D, as the mutation is accumulated, the basin size of the cell-migration state is increased, thereby increasing the basin size of the abnormal attractor.

Therefore, the protein discovery apparatus 100 may discover a target protein by comparing basin sizes of normal attractors and abnormal attractors included in normal cells and cancer cells perturbed with proteins.

Referring back to FIG. 2, the protein discovery apparatus 100 then selects one (or a combination) of a plurality of proteins (e.g., m proteins, where m is a natural number greater than 1) included in the body signal transferring network of a cancer cell and perturbs the selected protein, and then simulates the body signal transferring network of the perturbed cancer cell (S203)

In this case, ‘perturbation’ indicates changing the state of the selected protein, and the state of the perturbed protein may be changed into an active state or a non-active state. The body signal transferring network of the cancer cell may be generated by applying a mutation map for a cancer state to the body signal transferring network.

In the exemplary embodiment, when one protein is selected as a perturbation target, the simulation of the body signal transferring network may be performed a number of times corresponding to the number (e.g., m) of the proteins. In an alternative exemplary embodiment, in another exemplary embodiment of the invention, when a combination of the proteins is selected as a perturbation target, the simulation of the body signal transferring network of the perturbed cancer cell may be performed (2^{m}−1) times, for example.

Next, the protein discovery apparatus 100 according to the exemplary embodiment calculates a basin size of an attractor based on the simulation result of the body signal transferring network of the perturbed cancer cell (S204). When at least one of the proteins included in the body signal transferring network is perturbed, the basin size of the attractor may be reduced or increased after the simulation of the body signal transferring network, and the protein discovery apparatus 100 according to the exemplary embodiment may calculate the changed basin size. In this case, according to another exemplary embodiment of the invention, the protein discovery apparatus 100 may selectively calculate a basin size for a normal attractor or an abnormal attractor.

Next, the protein discovery apparatus 100 according to the exemplary embodiment compares the basin sizes of the attractors of the normal cell and the perturbed cancer cell. In this case, for the compassion of the basin size of an attractor, the protein discovery apparatus 100 according to the exemplary embodiment may use both the basin sizes of the normal attractor and the abnormal attractor as comparison targets, and may use one of the basin sizes of the normal attractor and the abnormal attractor as the comparison target. In this case, the protein discovery apparatus 100 may perform the calculation of the basin sizes of the attractors of the perturbed cancer cell a number of times corresponding to the number of the proteins included in the body signal transferring network, and thus the comparison of the basin sizes of the attractors may be performed the number of times corresponding to the number of the proteins included in the body signal transferring network at the least.

Next, the protein discovery apparatus 100 determines a target protein candidate among the proteins included in the body signal transferring network based on the comparison result of the basin sizes of the attractors (S206). In an exemplary embodiment, in the exemplary embodiment, when an attractor calculated as a result of perturbation of one protein has a basin size that is similar to the basin size of the attractor of the normal cell, the protein discovery apparatus 100 may determine the protein as a candidate of the target protein. In this case, the determination of whether the basin size of the attractor of the normal cell is similar to the basin size of the attractor of the perturbed cancer cell may be made through a predetermined threshold value. In an exemplary embodiment, when a difference between the basin size of the abnormal attractor among the attractors of the perturbed cancer cell and the basin size of the abnormal attractor among the attractors of the normal cell is smaller than the predetermined threshold value, the perturbed protein may be determined as a target protein candidate, for example.

The protein discovery apparatus 100 according to the exemplary embodiment simulates the body signal transferring network by perturbing a specific protein, and calculates the basin size of the attractor based on the simulation result. Accordingly, the basin size of the attractor based on the result of the simulation that is performed on one perturbed body signal transferring network may correspond to one protein.

In an alternative exemplary embodiment, according to another exemplary embodiment of the invention, the protein discovery apparatus 100 may compare a basin size ratio of the normal attractor and the abnormal attractor of the perturbed cancer cell with a basin size of the attractors of the normal cell. In this case, when the basin size ratio (e.g., 8:2) of the normal attractor and the abnormal attractor of the perturbed cancer cell is similar to the basin size of the attractors of the normal cell, the perturbed protein may be determined as a target protein candidate. In this regard, this determination may be made based on whether similarity of the basin size ratio or a difference between the basin size ratios exceeds a predetermined threshold value.

Referring back to FIG. 2, in the case of a plurality of target protein candidates (“Yes” in S207), the protein discovery apparatus 100 according to the exemplary embodiment may additionally perform the simulation on the body signal transferring network on a combination of the target proteins (S209) and may determine the combination of the target proteins based on the additional-simulation result (S208). However, in the case of one target protein candidate (“No” in S207), the protein discovery apparatus 100 may determine one target protein candidate as a target protein (S208).

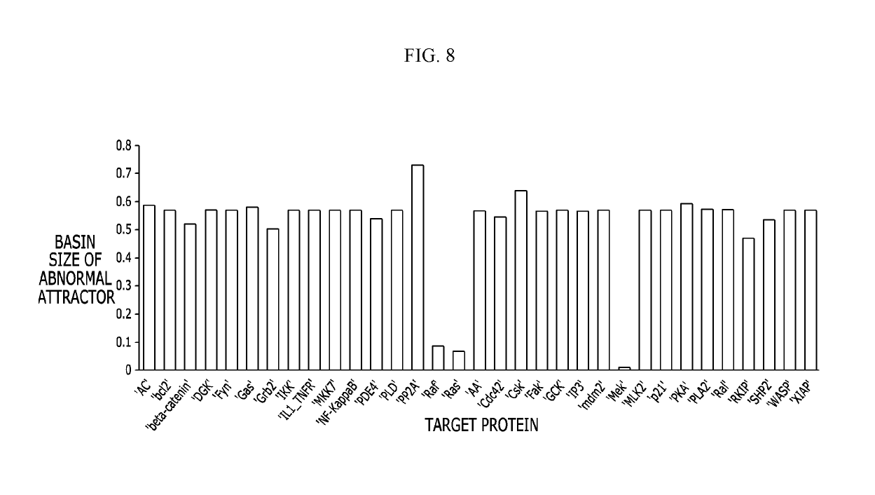

Hereinafter, a target protein discovery result of the protein discovery apparatus 100 and a target protein determining method will be described in detail with reference to FIG. 8. FIG. 8 is a graph illustrating a discovery result of target proteins according to an exemplary embodiment of the invention. Specifically, FIG. 8 is a graph illustrating the basin size of a cancer-progression attractor of a colorectal cancer cell. In this case, the cancer-progression attractor of the colorectal cancer cell may be acquired by applying a major mutation map of the body signal transferring network to generate the body signal transferring network of the colorectal cancer cell and performing attractor analysis on the generated body signal transferring network. The protein discovery apparatus 100 calculates a basin size of the cancer-progression attractor by perturbing 34 genes of well-known drug targets among the proteins included in the body signal transferring network. Referring to FIG. 8, when Raf, Ras, and Mek genes are perturbed, the basin size of the cancer-progression attractor is significantly reduced, and thus the Raf, Ras, and Mek genes are determined as the target proteins.

Next, the protein discovery apparatus 100 according to the illustrated exemplary embodiment may additionally perform the attractor analysis on a combination of the above-mentioned genes. In an exemplary embodiment, the attractor analysis on the cases where the Raf and Ras genes are simultaneously performed, where the Raf and Mek genes are simultaneously performed, where the Ras and Mek genes are simultaneously performed, and where the Raf, Ras, and Mek genes are simultaneously performed may be additionally performed, for example.

Next, the protein discovery apparatus 100 according to the exemplary embodiment may determine at least one of a plurality of target protein combinations as a target protein combination to which the target therapy is to be applied.

According to another exemplary embodiment of the invention, in the case where the protein discovery apparatus 100 simulates the body signal transferring network by perturbing a combination of proteins, when the basin size of the attractor calculated based on the simulation result is similar to the basin size of the attractor of the normal cell, the combination of proteins may be determined as a target protein combination.

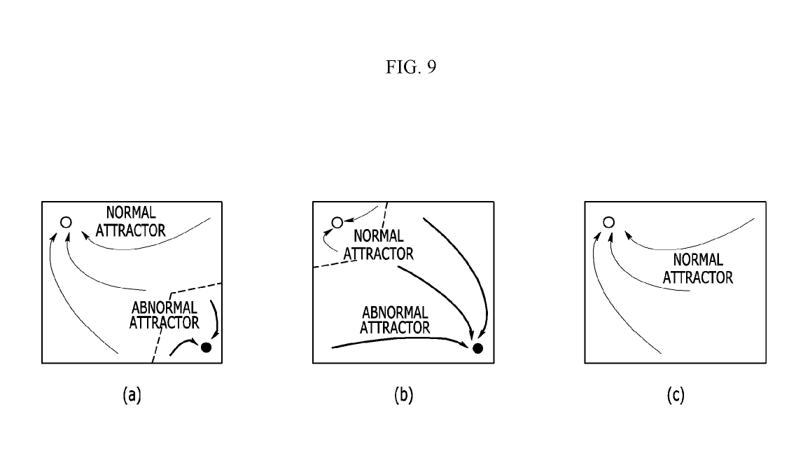

FIG. 9 illustrates cell attractor areas according to an exemplary embodiment of the invention.

FIG. 9 (a) illustrates an attractor area of a normal cell, FIG. 9 (b) illustrates an attractor area of a cancer cell, and FIG. 9 (c) illustrates an attractor area of a cancer cell perturbed with the target protein. Each attractor area includes a normal attractor and an abnormal attractor. Referring to FIG. 9 (a), in the attractor area of the normal cell, most states are converged into a normal attractor, and some states are converged into an abnormal attractor. Referring to FIG. 9 (b), in the attractor area of the cancer cell, most states are converged into an abnormal attractor, and some states are converged into a normal attractor. Referring to FIG. 9 (c), as opposed to the attractor area of the normal cell, in the attractor area of the cancer cell perturbed with the target protein, most states are converged into a normal state. In brief, the attractor area of the cancer cell perturbed with the target protein is substantially similar to the attractor area of the normal cell.

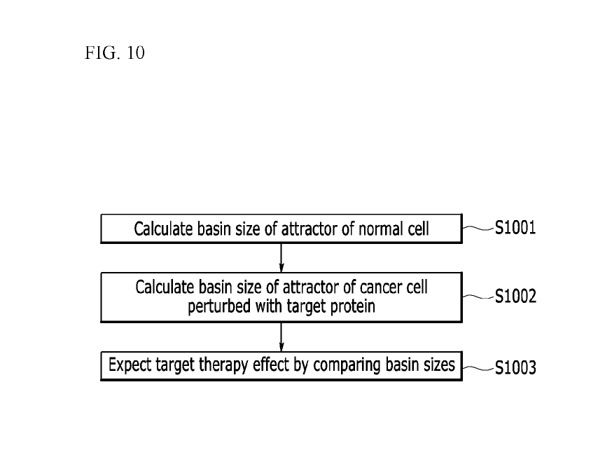

FIG. 10 illustrates a method of expecting an effect of a target therapy of a target protein according to an exemplary embodiment of the invention.

Referring to FIG. 10, first, the basin size of the attractor of the normal cell is calculated (S1001). Next, the basin size of the attractor of the cancer cell perturbed with the target protein is calculated (S1002)

Finally, the comparison of the basin size of the attractor of the normal cell and the basin size of the attractor of the cancer cell perturbed with the target protein is performed, and a target therapy effect is expected according to the comparison result (S1003). As a result, as the basin size of the attractor of the cancer cell perturbed with the target protein approaches the basin size of the attractor of the normal cell, an outstanding target therapy effect may be expected.

FIG. 11 is a block diagram illustrating a protein discovery apparatus according to an exemplary embodiment of the invention.

Referring to FIG. 11, the protein discovery apparatus 100 according to the illustrated exemplary embodiment includes a processor 101, a memory 102, and a transceiver 103. The memory 102 may be connected to the processor 101 to store various information for driving the processor 101. The transceiver 103 may be connected to the processor 101 to transmit and receive wire or wireless signals to and from a terminal and a server. The processor 101 may realize functions, operations, and methods suggested in the exemplary embodiment of the invention. The operations of the protein discovery apparatus 100 according to the exemplary embodiment may be realized by the processor 101.

In the exemplary embodiment of the invention, the memory 102 may be disposed inside or outside the processor 101, and may be connected to the processor 101 through various already known means. In an exemplary embodiment, the memory 102 may be various types of volatile or non-volatile storage media, and may include, for example, a read-only memory (“ROM”) or a random access memory (“RAM”).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of discovering a protein which serves as a target of a target therapy, the method comprising:
performing an attractor analysis on a first body signal transferring network of a perturbed cancer cell; and
determining at least one of a plurality of proteins included in a third body signal transferring network of a cancer cell as a target protein based on the attractor analysis on the first body signal transferring network and an attractor analysis on a second body signal transferring network of a normal cell.

2. The protein discovery method of claim 1, wherein the performing the attractor analysis includes:
modeling the third body signal transferring network by applying a mutation map of a cancer state to the second body signal transferring network;
modeling the first body signal transferring network by perturbing at least one of the plurality of proteins included in the third body signal transferring network; and
simulating a signal-transmitting operation of the first body signal transferring network by using a Boolean network model.

3. The protein discovery method of claim 2, wherein the modeling of the first body signal transferring network includes modeling the first body signal transferring network by perturbing a combination of some of the plurality of proteins included in the third body signal transferring network.

4. The protein discovery method of claim 2, wherein the simulating the signal-transmitting operation includes:
determining the Boolean network model relating to a mutual relationship of proteins included in the first body signal transferring network; and
time-dynamically simulating the first body signal transferring network based on the Boolean network model.

5. The protein discovery method of claim 4, wherein the simulating the signal-transmitting operation includes:
generating a truth table relating to the mutual relationship of the proteins included in the first body signal transferring network based on the Boolean network model;
generating a state transition table showing state transition of the proteins based on the truth table; and
determining an attractor indicating a final state of each protein included in the first body signal transferring network by generating a state transition diagram based on the state transition table.

6. The protein discovery method of claim 1, wherein the simulating the signal-transmitting operation includes calculating a basin size of an attractor of the perturbed cancer cell based on the simulation result of the first body signal transferring network.

7. The protein discovery method of claim 6, wherein the determining at the least one of the plurality of proteins included in the third body signal transferring network of the cancer cell as the target protein includes:
comparing a basin size of an abnormal one of attractors of the normal cell with a basin size of an abnormal one of attractors of the perturbed cancer cell; and,
when a difference between the basin size of the abnormal one of the attractors of the normal cell with the basin size of the abnormal one of the attractors of the perturbed cancer cell is smaller than a predetermined value,
determining at least one perturbed protein of the plurality of proteins included in the third body signal transferring network as the target protein.

8. The protein discovery method of claim 6, wherein the determining at the least one of the plurality of proteins included in the third body signal transferring network of the cancer cell as the target protein includes:
comparing a first basin size ratio of normal attractors and abnormal attractors among attractors of the normal cell with a second basin size ratio of normal attractors and abnormal attractors among attractors of the perturbed cancer cell; and,
when a difference between the first basin size ratio and the second basin size ratio is smaller than a predetermined value,
determining at least one perturbed protein of the plurality of proteins included in the third body signal transferring network as the target protein.

9. The protein discovery method of claim 7, wherein the determining the at least one perturbed protein of the plurality of proteins included in the third body signal transferring network as the target protein further includes, when at least two of the proteins included in the third body signal transferring network are the target protein, determining at least one of combinations of the at least two proteins as the target protein.

10. The protein discovery method of claim 9, wherein the determining the at the least one of combinations of the at least two proteins as the target protein includes,
when at least two of the proteins included in the third body signal transferring network are the target protein:
generating a fourth body signal transferring network by making combinations of the at least two proteins and perturbing the combinations of the at least two proteins; and
re-performing the attractor analysis on the fourth body signal transferring network.

11. A discovery apparatus of a protein which serves as a target of a target therapy, the discovery apparatus comprising:
at least one processor;
a memory; and
a transceiver,
wherein the at least one processor executes at least one program stored in the memory to perform:
performing an attractor analysis on a first body signal transferring network of a perturbed cancer cell; and
determining at least one of a plurality of proteins included in a third body signal transferring network of a cancer cell as a target protein based on the attractor analysis on the first body signal transferring network and an attractor analysis on a second body signal transferring network of a normal cell.

12. The protein discovery apparatus of claim 11, wherein the at least one processor performs:
modeling the third body signal transferring network by applying a mutation map of a cancer state to the second body signal transferring network;
modeling the first body signal transferring network by perturbing at least one of the plurality of proteins included in the third body signal transferring network; and
simulating a signal-transmitting operation of the first body signal transferring network by using a Boolean network model.

13. The protein discovery apparatus of claim 12, wherein the at least one processor, when performing the modeling of the first body signal transferring network, performs:
modeling the first body signal transferring network by perturbing a combination of some of the plurality of proteins included in the third body signal transferring network.

14. The protein discovery apparatus of claim 12, wherein the at least one processor, when performing the simulating of the signal-transmitting operation, performs:
determining the Boolean network model relating to a mutual relationship of the proteins included in the first body signal transferring network; and
time-dynamically simulating the first body signal transferring network based on the Boolean network model.

15. The protein discovery apparatus of claim 14, wherein the at least one processor, when performing the time-dynamical simulating, performs:
generating a truth table relating to the mutual relationship of the proteins included in the first body signal transferring network based on the Boolean network model;
generating a state transition table showing state transition of the proteins based on the truth table; and
determining an attractor indicating a final state of each protein included in the first body signal transferring network by generating a state transition diagram based on the state transition table.

16. The protein discovery apparatus of claim 11, wherein the at least one processor performs:
calculating a basin size of an attractor of the perturbed cancer cell based on a simulation result of the first body signal transferring network.

17. The protein discovery apparatus of claim 16, wherein the at least one processor, when performing the determining the at least one of the plurality of proteins, performs:
comparing a basin size of an abnormal one of attractors of the normal cell with a basin size of an abnormal one of attractors of the perturbed cancer cell; and,
when a difference between the basin size of the abnormal one of the attractors of the normal cell and the basin size of the abnormal one of the attractors of the perturbed cancer cell is smaller than a predetermined value,
determining at least one perturbed protein of the plurality of proteins included in the third body signal transferring network as the target protein.

18. The protein discovery apparatus of claim 16, wherein the at least one processor, when performing the determining the at least one of the plurality of proteins, performs:
comparing a first basin size ratio of normal attractors and abnormal attractors among attractors of the normal cell with a second basin size ratio of normal attractors and abnormal attractors among attractors of the perturbed cancer cell; and,
when a difference between the first basin size ratio and the second basin size ratio is smaller than a predetermined value,
determining at least one perturbed protein of the plurality of proteins included in the third body signal transferring network as the target protein.

19. The protein discovery apparatus of claim 17, wherein the at least one processor, when performing the determining, performs:
when at least two of the plurality of proteins included in the third body signal transferring network are determined as the target protein, determining at least one of combinations of the at least two proteins as the target protein.

20. The protein discovery apparatus of claim 19, wherein the at least one processor, when performing the determining, performs:
when at least two of the plurality of proteins included in the third body signal transferring network are determined as the target protein:
generating a fourth body signal transferring network by making combinations of the at least two proteins and perturbing the combinations of the at least two proteins; and
re-performing the attractor analysis on the fourth body signal transferring network.
